(19) United States
(12) Patent Application Publication
(10) Pub. No.: US 2025/0216533 A1
(43) Pub. Date: Jul. 3, 2025

(54) SYSTEMS AND METHODS FOR IMPACT DETECTION IN AN ENVIRONMENT

(71) Applicant: Universal City Studios LLC, Universal City, CA (US)

(72) Inventors: David Gerard Majdali, Orlando, FL (US); Gregory Paul Habiak, Orlando, FL (US); Wei Cheng Yeh, Orlando, FL (US)

(21) Appl. No.: 18/902,418

(22) Filed: Sep. 30, 2024

Related U.S. Application Data
(60) Provisional application No. 63/615,647, filed on Dec. 28, 2023.
(60) Provisional application No. 63/615,635, filed on Dec. 28, 2023.
(60) Provisional application No. 63/640,773, filed on Apr. 30, 2024.

(51) Int. Cl. G01S 13/06; G01S 13/02; G08B 21/18

(52) U.S. Cl. CPC G01S 13/06; G01S 13/0209; G08B 21/182

(57) ABSTRACT

An impact detection system includes processing circuitry with one or more processors. The impact detection system also includes memory storing instructions, that when executed by the processing circuitry, cause the processing circuitry to process positioning data to determine a position of a portable device within an interactive environment, compare the position of the portable device to a location of a component within the interactive environment, identify an occurrence of an impact event based on the position of the portable device corresponding to the location of the component, and update an impact profile for at least the portable device or the component based on the occurrence of the impact event.

### CROSS-REFERENCE TO RELATED APPLICATIONS

This application claims priority to and the benefit of U.S. Provisional Application No. 63/615,647, entitled “SYSTEMS AND METHODS FOR IMPACT DETECTION IN AN ENVIRONMENT” and filed Dec. 28, 2023, and also claims priority to and the benefit of U.S. Provisional Application No. 63/615,635, entitled “SYSTEMS AND METHODS FOR DROP DETECTION OF PORTABLE DEVICES” and filed Dec. 28, 2023, and also claims priority to and the benefit of U.S. Provisional Application No. 63/640,773, entitled “SYSTEMS AND METHODS FOR DETECTING HANDLING EVENTS FOR PORTABLE DEVICES” and filed Apr. 30, 2024, which are incorporated by reference herein in their entireties for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment venue, the entertainment venue may include objects (e.g., props or toys) that provide special effects. For example, the special effects may provide customized special effects based on guests' experiences within the entertainment venue, as well as support a particular narrative in the entertainment venue. Additionally or alternatively, the objects may facilitate interactions between the guests and interactive elements in the entertainment venue. For example, the guests may move the objects in particular gestures to cause animated characters to perform show effects.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, an impact detection system includes processing circuitry with one or more processors. The impact detection system also includes memory storing instructions, that when executed by the processing circuitry, cause the processing circuitry to process positioning data to determine a position of a portable device within an interactive environment, compare the position of the portable device to a location of a component within the interactive environment, identify an occurrence of an impact event based on the position of the portable device corresponding to the location of the component, and update an impact profile for the component based on the occurrence of the impact event.

In an embodiment, an interactive system includes a component positioned in an interactive environment, wherein the component includes an array of ultra-wideband (UWB) tags, one or more sensors, or both. The interactive system also includes a control system with one or more processors and memory storing instructions, that when executed by the control system, cause the control system to process data to determine occurrence of an impact event at the component, wherein the data is generated by UWB anchors based on communication with the array of UWB tags, by the one or more sensors, or both. The instructions, when executed by the control system, also cause the control system to update an impact profile for the component based on the occurrence of the impact event and assess the updated impact profile for the component to identify maintenance operations due for the component.

In an embodiment, a method of operating an impact detection system includes processing positioning data generated by ultra-wideband circuitry to identify an occurrence of an impact event for the component. The method also includes updating an impact profile for the component based on the occurrence of the impact event. The method further includes assessing the updated impact profile for the component to identify maintenance operations due for the component.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an interactive system with an impact detection system, in accordance with present embodiments;

FIG. 2 is a schematic diagram of a portable device with a form of a handheld portable device and a respective impact profile for the handheld portable device, in accordance with present embodiments;

FIG. 3 is a schematic diagram of a portable device with a form of a wearable portable device and a respective impact profile for the wearable portable device, in accordance with present embodiments;

FIG. 4 is an example of a graphical user interface (GUI) that presents information related to an impact status for multiple portable devices and a respective impact profile for at least one of the multiple portable devices, in accordance with present embodiments;

FIG. 5 is a flow diagram of a method of operating an impact detection system to assess a tracked quantity of occurrences of impacts at a region of a portable device, in accordance with present embodiments;

FIG. 6 is a schematic illustration of guests within an interactive environment with one or more impact detection boundaries and one or more impact detection zones, in accordance with present embodiments;

FIG. 7 is a schematic illustration of the guests within the interactive environment that includes one or more components, in accordance with present embodiments;

FIG. 8 is an example of a GUI that presents information related to an impact status for the one or more components of FIG. 7, in accordance with present embodiments; and

FIG. 9 is a flow diagram of a method of operating an impact detection system to assess a tracked quantity of occurrences of impacts at a region of a component, in accordance with present embodiments.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Additionally, it should be understood that references to “an embodiment” of the present disclosure are not intended to be interpreted as excluding the existence of additional embodiments that also incorporate the recited features.

As used herein, machine learning may refer to algorithms and statistical models that computing systems may use to perform a specific task with or without using explicit instructions. For example, a machine learning process may generate a mathematical model based on a sample of clean data, known as “training data,” in order to make predictions or decisions without being explicitly programmed to perform the task.

The present disclosure relates generally to an interactive environment that utilizes portable devices to provide interactive experiences to guests (e.g., users). In an embodiment, the interactive environment is implemented within an amusement park attraction, such as in a ride attraction in which the guests are carried in ride vehicles through the interactive environment and/or a walk-through attraction in which the guests walk through the interactive environment. In an embodiment, the amusement park attraction may be a hybrid attraction in which the guests are both carried (e.g., on a moving walkway) and are permitted to walk (e.g., along the moving walkway) through the interactive environment. The interactive environment may be distributed across multiple different amusement park attractions (e.g., geographically separated from one another), such as across multiple different ride attractions, walk-through attractions, and/or hybrid attractions. Additionally or alternatively, the interactive environment may be implemented within one or more other types of venues, such as one or more restaurants, one or more hotels, one or more theatres, one or more stadiums, and/or one or more schools. Additionally or alternatively, the interactive environment may be included within one or more themed areas and/or distributed across multiple different themed areas having a common theme or different themes. Additionally or alternatively, the interactive environment may include a live show (e.g., with performers), and the guests in an audience may participate in the live show using the portable devices.

The portable devices may be any of a variety of types of devices that are configured to be carried, such as held and/or worn, by the guests. For example, the portable devices may include targeting devices (e.g., blasters), wands, toys, figurines, clothing, jewelry, bracelets, headgear, medallions, glasses (e.g., augmented reality (AR) and/or virtual reality (VR) glasses), and/or any combination thereof (e.g., targeting devices integrated into bracelets). In an embodiment, the portable devices may be configured to be used by multiple different guests over time. For example, a guest may pick up a portable device at an entrance to the interactive environment, use the portable device to participate in the interactive environment as the guest travels through the interactive environment, and then return the portable device as the guest exits the interactive environment. The portable device may be made available again at the entrance to the interactive environment (e.g., after cleaning and/or sterilizing), and then another guest may pick up the portable device at the entrance to the interactive environment and use the portable device to participate in the interactive environment, and so on.

In an embodiment, the portable devices may enable the guests to interact with (e.g., to control) features within the interactive environment. For example, a portable device may be a targeting device, and the guest may actuate an input mechanism (e.g., trigger switch, push-button) of the portable device to initiate a simulation of a delivery (e.g., virtual delivery) of a virtual projectile toward an interactive element (e.g., a physical interactive element in a physical, real-world space or a virtual interactive element in a virtual space on a display) within the interactive environment. In response, the interactive environment may portray the virtual projectile landing on (e.g., “striking” or “hitting”) the interactive element. For example, the display may display an image (e.g., moving image; video) that portrays the virtual projectile landing on (e.g., “striking” or “hitting”) a virtual interactive element. In another example, a change in the behavior of a physical interactive element or presence of special effects (e.g., sound, light, smoke, vibrations) in the interactive environment may indicate a successful targeting of the physical interactive element. In another example, successful targeting and/or timing of actuation of an input mechanism may include aiming at the interactive element and actuating the input mechanism while aiming at the interactive element. It should be appreciated that the physical interactive element may be a prop or a physical object in the physical, real-world space within the interactive environment, and the virtual interactive element may be an image/animation of a virtual object displayed in the virtual space on the display. In an embodiment, a hybrid interactive element may be a physical interactive element and a virtual interactive element simultaneously by having physical portions in the physical, real-world space within the interactive environment and virtual portions displayed in the virtual space on the display. Herein, “interactive element” generally refers to any physical interactive element, virtual interactive element, or hybrid interactive element.

In an embodiment, the portable devices may enable the guests to view virtual features (e.g., imagery) within the interactive environment. For example, a portable device may be a wearable visualization device (e.g., AR and/or VR glasses), such as a head mounted display that may be worn by the guest and may be configured to enable the guest to view the virtual features. In particular, the wearable visualization device may be utilized to enhance a guest experience by overlaying the virtual features onto a real-world environment, by providing adjustable virtual environments to provide different experiences, and so forth. As noted herein, the portable devices may include other types of devices, such as a wand or a bracelet that may be moved through space in a particular manner to initiate a change to the interactive element.

Advantageously, disclosed embodiments provide an impact detection system that is configured to monitor whether the portable devices are improperly handled (e.g., experience an adverse or potentially damaging event, such as a drop or a throw that results in contact with a surface; impact events). In particular, the impact detection system may include position circuitry, such as ultra-wideband (UWB) circuitry and/or inertial measurement units [IMU] and associated circuitry, that generates and/or indicates position data and/or orientation data for the portable devices.

In an embodiment, the position circuitry may include respective UWB tags, such as an array of UWB tags, on each of the portable devices, as well as UWB readers in the real-world environment. Communication between the UWB tags and the UWB readers may indicate the position data and/or the orientation data. Additionally or alternatively, the position circuitry may include respective IMUs on each of the portable devices to generate the position data and/or the orientation data. In some instances, signals generated by the UWB components may be processed to derive or estimate acceleration data and/or velocity data. When present, the IMUs may provide acceleration data and/or velocity data. In any case, the position circuitry may provide the position data, the orientation data, the acceleration data, and/or the velocity data to a control system (e.g., electronic control system), which may determine whether any of the portable devices are improperly handled and may cause one or more actions in response to determining that at least one of the portable devices is improperly handled.

It should be appreciated that techniques disclosed herein to monitor impact events for the portable devices may be performed without the IMUs or any accelerometers on the portable devices. For example, the portable devices may be devoid of the IMUs and the accelerometers. Instead, the position data, the orientation data, the acceleration data, and/or the velocity data may be obtained via radiofrequency communication circuitry, such as via the UWB circuitry that includes the UWB tags on the portable devices and the UWB readers in the real-world environment. In such cases, the portable devices may be lower cost and/or simpler (e.g., fewer components), and various processing aspects may be shifted to and performed at the control system.

It is presently recognized that certain motions of the portable devices may result in acceleration data that mimics or appears to be impact events. Accordingly, in an embodiment, the control system may reference a map (e.g., a virtual three-dimensional (3D) model) of the real-world environment to confirm (e.g., verify) that the portable devices impact a boundary prior to classifying and/or counting impact events (e.g., a drop or a throw that results in contact with a surface). The boundary may include a surface, such as an impact detection boundary, a fixed or stationary surface, a floor, a ceiling, a side wall, a physical interactive element, a display, one of the guests, an object carried by one of the guests, another portable device, a movable or non-stationary surface, and so forth.

Further, it is also recognized that different regions (e.g., zones, areas) of the portable devices may have different susceptibility to damage. For example, a first region (e.g., a solid metal housing region) may be capable of withstanding a first number (e.g., many, such as at least 5, 10, 15, 20, 25, 50, 100 or more) of impact events, while a second region (e.g., a plastic frame around a display) may be damaged after a second number (e.g., few, such as no more than 1, 2, 3, 4, 5, 10, or 20) of impact events. Accordingly, in an embodiment, the control system may generate (e.g., based on prior data, such as historical data and/or modeled data) and/or utilize respective thresholds for the different regions of the portable devices.

In this way, for a particular portable device, the impact detection system may identify an improper handling event based on data from the position circuitry and determine that the improper handling event is an impact event with contact between the particular portable device and a boundary (e.g., by reference to the map). Further, the impact detection system may determine the position and/or the orientation of the particular portable device at a time of impact with the boundary in order to determine a region of the particular portable device that impacted the boundary, increment a total tracked quantity of occurrences of impact events for the region (e.g., add one to the total tracked quantity of occurrences of impact events for the region), compare the total tracked quantity of occurrences of impact events for the region to a respective threshold for the region, and provide an alert in response to the total tracked quantity of occurrences of impact events for the region exceeding the respective threshold for the region. Thus, the impact detection system may facilitate efficient removal and maintenance of any portable device that may be damaged due to being improperly handled and may facilitate operation of the interactive environment so that the guests are able to experience the interactive environment with functioning portable devices.

Further, over time, the impact detection system may build and generate respective impact profiles for the portable devices. For example, the respective impact profile for the particular portable device may indicate a respective total tracked quantity of occurrences of impact events for each region of the particular portable device, and the respective impact profile for the particular portable device may be updated upon each impact event for the particular portable device. In this way, an operator may request and/or access the respective impact profiles for the portable devices, which may facilitate maintenance operations for the portable devices. Further, the respective impact profiles for the portable devices may be utilized to inform design, construction, and/or maintenance for the portable devices. For example, the respective impact profiles for the portable devices and/or inputs related to operations of the portable devices may be utilized to update the design (e.g., to reposition features that experience frequent impact and/or damage), the construction (e.g., to add reinforcing materials in certain regions), and/or to adjust the respective thresholds to trigger inspection and maintenance (e.g., certain regions may be determined to be studier than initially expected).

In an embodiment, the impact detection system may detect and track respective impact events for one or more components in the interactive environment. For example, the impact detection system may detect and track the respective impact events due to contact between the portable devices and the one or more components in the interactive environment. The impact detection system may detect and track the respective impact events due to contact between other objects, such as the guests, and the one or more components in the interactive environment.

The impact detection system may utilize the position and/or the orientation of the portable device, as well as the map that indicates respective locations of the one or more components to determine the respective impact events due to contact between the portable devices and the one or more components in the interactive environment. Additionally or alternatively, the impact detection system may utilize other types of data, such as sensor data from one or more sensors coupled to the one or more components, to determine the respective impact events due to contact between the portable devices and the one or more components in the interactive environment. Further, the impact detection system may use the other types of data to determine the respective impact events due to contact between other objects, such as the guests, and the one or more components in the interactive environment.

The impact detection system may count a respective total tracked quantity of occurrences of impact events for each region of each of the one or more components and/or a respective total tracked quantity of occurrences of impact events for each of the one or more components. In this way, the impact detection system may build and generate respective impact profiles for the one or more components. The impact detection system may also utilize respective thresholds for each region of each of the one or more components and/or for each of the one or more components, wherein the respective thresholds trigger alerts for maintenance operations, for example.

The operator may request and/or access the respective impact profiles for the one or more components, which may facilitate maintenance operations for the one or more components. Further, the respective impact profiles for the one or more components may be utilized to inform design, construction, and/or maintenance for the one or more components and/or the interactive environment. For example, the respective impact profiles for the one or more components may be utilized to update the design (e.g., to reposition a component that experiences frequent impact and/or damage), update the construction (e.g., to add reinforcing materials in a certain region of the component), and/or adjust the respective thresholds to trigger inspection and maintenance (e.g., certain regions may be determined to be sturdier than initially expected).

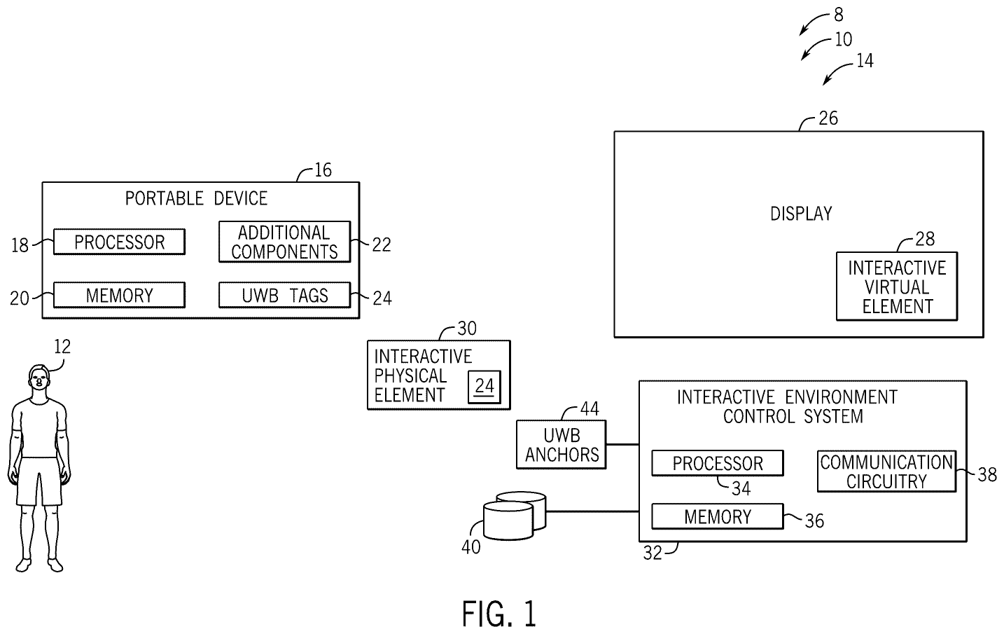

With the foregoing in mind, FIG. 1 illustrates an interactive system 8 with an impact detection system 10, in accordance with an embodiment of the present disclosure. The interactive system 8 includes or is associated with an interactive environment 14, which may be within an amusement park attraction and/or other suitable venue. As shown, a guest 12 (e.g., user) may carry or otherwise be associated with a portable device 16 that may include a processor 18, a memory device 20, and/or additional components 22. The additional components 22 may include an input mechanism (e.g., trigger switch, push-button), a light emitter (e.g., light emitting diode [LED]), a haptic device, a display (e.g., a display screen), a battery, a battery management system, a speaker, a microphone, an inertial measurement unit (IMU), near-field communication (NFC) circuitry, and/or an ultra-high frequency (UHF) circuitry. In an embodiment, the portable device 16 may be used to interact with interactive elements.

Advantageously, the portable device 16 may be equipped with ultra-wideband (UWB) tags 24 (e.g., antennas) that enable monitoring (e.g., continuous monitoring) of a position and/or an orientation of the portable device 16 (e.g., relative to a coordinate system) within the interactive environment 14. In addition, UWB circuitry (e.g., a UWB system) may include the UWB tags 24. The UWB circuitry may generate and efficiently communicate position data and/or orientation data, which may enable an interactive environment control system 32 (also referred to herein as “a control system 32”) to accurately determine interaction with the interactive elements via the portable device 16 (e.g., successful targeting and/or gestures). The UWB tags 24 may be arranged to extend in two-dimensions or in three-dimensions (e.g., not in a linear row; in a cross-shape or an x-shape; distributed or spaced related to one another along at least two of an x-axis, a y-axis, or a z-axis).

It should be appreciated that any other suitable components may be utilized to detect the position and/or the orientation of the portable device 16. For example, such components may include: one or more sensors, such as IMUs and/or accelerometers, on the portable device 16, and communication circuitry to send data from the sensors to the control system 32; one or more sensors, such as imaging sensors/cameras, off-board the portable device 16 and in the interactive environment 14; one or more light emitters and one or more light detectors, such as one or more light emitters on the portable device 16 and one or more light detectors off-board the portable device 16 and in the interactive environment 14; and/or one or more light reflectors, one or more light emitters, and one or more light detectors, such as one or more retroreflectors on the portable device 16 and one or more light emitters off-board the portable device 16 to emit light toward the portable device 16 and one or more detectors off-board the portable device 16 to detect the light reflected by the one or more retroreflectors. However, in an embodiment, no light emitters, lasers, or line-of-sight sensing devices are utilized to detect the position and/or the orientation of the portable devices 16. Further, the UWB circuitry and/or the one or more sensors may be used to determine the position, orientation, velocity, and/or acceleration of the portable device 16. As noted herein, in some cases the portable device 16 may be devoid of the IMUs and the accelerometers, and the portable device 16 may utilize the UWB circuitry to monitor the position, the orientation, the acceleration, and/or the velocity of the portable device 16.

The interactive environment 14 may include one or more displays 26 (e.g., display screens) that may be configured to display virtual interactive elements 28. The virtual interactive elements 28 may include images (e.g., moving images; videos), such as symbols, coins, prizes, vehicles, and/or characters. The images may include, for example, animated objects. The animated objects, for example, may include symbols, coins, prizes, vehicles, and/or characters. The virtual interactive elements 28 may move in two dimensions (2D) in the virtual space on the display 26. In addition, the interactive environment 14 may include one or more physical interactive elements 30 that may be placed or built into the interactive environment 14. The physical interactive elements 30 may include physical structures, props, vehicles, and/or robots. The physical interactive elements 30 may move and/or actuate in one dimension, two dimensions, and/or three dimensions in the physical, real-world space within the interactive environment 14.

As the guest 12 travels through the interactive environment 14, the guest 12 may be presented with the interactive elements. For example, images of animated objects may move (e.g., appear to move) across the display 26 and/or robots may move in the interactive environment 14. The guest 12 may use the portable device 16 to virtually interact with the interactive elements, such as by actuating the input mechanism on the portable device 16 to launch virtual projectiles toward the interactive elements and/or moving the portable device 16 through space to cause changes to the interactive elements. In such cases, virtual projectiles may not have a physical embodiment or actual representation (e.g., virtual projectiles may not be seen or sensed; may not be present in the physical, real-world space and/or in the virtual space). However, in an embodiment, images of the virtual projectiles may be shown on the display 26. In an embodiment, the interactive system 8 may award points (e.g., achievements) to the guest 12 for each successful interaction (e.g., each “strike” or target gesture) with at the interactive elements and the points may be added to a guest profile of the guest 12. The guest profile of the guest 12 may be stored in one or more databases 40, such that the guest profile of the guest 12 may be maintained and updated across multiple visits to the interactive environment 14.

The control system 32 may be responsible for controlling the physical interactive elements 30 and the virtual interactive elements 28 to produce responses to virtual interactions (also referred to herein as “interactions”) between the portable devices 16 and the interactive elements in the interactive environment 14. For example, the control system 32 may calculate trajectories of virtual projectiles with an aim of determining whether the virtual projectiles should be considered to reach a target, such as based on the position data and/or the orientation data during the actuation of the input mechanism.

The control system 32 may include a processor 34, a memory device 36, and communication circuitry 38 to enable the control system 32 to control features within the interactive environment 14, such as to control the interactive elements and/or produce special effects in the interactive environment 14, as well as to communicate with the portable device 16. The processor 34, the memory device 36, and the communication circuitry 38 may enable the control system 32 to receive and process the position data, the orientation data, the acceleration data, and/or the velocity data to determine occurrence of and count impact events, determine and track regions of impact during the impact events, and so forth

The memory device 36 may include one or more tangible, non-transitory, computer-readable media that store instructions executable by the processor 34 and/or store data (e.g., guest profile) to be processed by the processor 34. For example, the memory device 36 may include random access memory (RAM), read only memory (ROM), rewritable non-volatile memory such as flash memory, hard drives, optical discs, and/or the like. Additionally, the processor 34 may include one or more general purpose microprocessors, one or more application specific processors (ASICs), one or more field programmable gate arrays (FPGAs), or any combination thereof. Further, the memory device 36 may store instructions executable by the processor 34 to perform the methods and control actions described herein for the interactive system 8.

The control system 32 may include or represent a processing system (e.g., processing circuitry; computing system), including a cloud-computing system, a distributed computing system, or any suitable type of computing system. Further, the control system 32 may include or represent the processing system with the processor 34, which may include or represent multiple processors. In such cases, certain processing operations may be performed by one of the multiple processors, other processing operations may be performed by another one of the multiple processors, and so forth. Additionally, it should be appreciated that processing operations may be divided and/or shared with the processor 18 of the portable device 16. Indeed, certain processing operations described herein may be performed by the processor 18 of the portable device 16 in certain circumstances or in certain configurations.

It is presently recognized that it would be desirable to monitor and track impact events for the portable device 16. In an embodiment, one or more sensors of the additional components 22 of the portable device 16, such as the IMU, may detect an acceleration (e.g., a sudden acceleration or deceleration) or change in acceleration (e.g., an increase and/or decrease in acceleration) of the portable device 16. For example, if the guest 12 drops the portable device 16 (e.g., in free fall toward the ground/along a gravity vector), the one or more sensors may detect an acceleration and may provide signals to the processor 34, which may process the signals by comparing the acceleration (e.g., maximum acceleration value) to an acceleration threshold (e.g., acceleration threshold value). The processor 34 may be configured to determine that the portable device 16 has been dropped or thrown in response to determining that the acceleration exceeds the acceleration threshold. It should be appreciated that the acceleration is a broad term that encompasses various ways of detecting dropping and/or throwing, and thus, the acceleration may be negative and the acceleration threshold may be a negative acceleration threshold (e.g., due to falling) or the acceleration threshold may be considered to be a deceleration threshold (e.g., due to a sudden stop due to an impact).

The processor 34 may also be configured to determine and analyze the position, orientation, velocity, and/or acceleration over time (e.g., acceleration pattern or signature) to determine whether the portable device 16 has been improperly handled and/or to identify impact with a boundary. It should be appreciated that the one or more sensors may additionally or alternatively detect various other parameters, such as deceleration, an angular rate, a velocity, and/or an orientation of the portable device 16 (e.g., relative to the gravity vector), and the one or more sensors may provide signals to the processor 34 for analysis to determine whether the portable device 16 has been improperly handled and/or to identify impact with the boundary.

In an embodiment, the UWB tags 24 of the portable device 16 may be detected by UWB anchors 44 in the interactive environment 14. In particular, the UWB tags 24 and the UWB anchors 44, which are in communication with the control system 32, may be part of a real-time locating system that performs continuous location tracking (e.g., position and/or orientation tracking) of the portable device 16 within the interactive environment 14. For example, the UWB tags 24 on the portable device 16 may communicate with the UWB anchors 44, which may be distributed throughout the interactive environment 14, to send positioning data. The UWB anchors 44 may then send the positioning data to the processor 34.

In an embodiment, mapping of the interactive environment 14 may include mapping the physical interactive elements 30, surfaces (e.g., floor, ceiling, side walls) that define the interactive environment 14, and the portable device 16 to a coordinate system (e.g., local coordinate system). Further, the mapping may be dynamic and may account for movement of the physical interactive elements 30 and the portable device 16. In an embodiment, locations of the physical interactive elements 30 may be known without use of the UWB tags 24 (e.g., programmed movements as part of the show). In an embodiment, the locations of the physical interactive elements 30 may be determined based on detection of UWB tags 24 and/or one or more sensors (e.g., on-board and/or off-board the physical interactive elements 30).

The processor 34 may access a map of the interactive environment 14 to identify and/or to assess impact events. For example, the processor 34 may utilize the positioning data indicated by the UWB circuitry to track the position and/or the orientation of the portable device 16 relative to boundaries indicated in the map. If the processor 34 determines that the positioning data indicates that the portable device 16 aligns with or meets one of the boundaries indicated in the map, the processor 34 may determine occurrence of an impact event for the portable device 16. Additionally, the processor 34 may utilize the positioning data indicated by the UWB circuitry to determine that a particular region of the portable device 16 contacts the surface. For example, if the processor 34 determines that the portable device is inverted upon contact with a floor, then the processor 34 may determine that a top region of the portable device contacts the surface. It should be appreciated that the processor 34 may also access a model (e.g., a three-dimensional (3D) model) of the portable device 16 to determine the occurrence of the impact event for the portable device 16, as well as to determine the particular region of the portable device 16 that contacts the surface. Further, the processor 34 may track the impact events and/or respective regions of the impact events for the portable device 16 to generate a respective impact profile for the portable device.

It should be appreciated that the processor 34 may also consider the data provided by the one or more sensors, including the acceleration data provided by the IMU. For example, the acceleration data may indicate a time of contact between the portable device 16 and the surface (e.g., a time of impact) and/or other information about the impact event (e.g., a force of impact; a velocity at the time of impact). In an embodiment, a sudden change in the acceleration may trigger assessment of the positioning data indicated by the UWB circuitry to determine whether the portable device 16 aligned with one of the boundaries indicated in the map. For example, upon or in response to the sudden change in the acceleration, the processor 34 may access and analyze the positioning data for some period of time before and after the sudden change in the acceleration to determine whether the portable device 16 aligned with one of the boundaries indicated in the map and whether the sudden change in acceleration should be counted as an impact event or discarded as merely motion in space without impact (e.g., a quick change of direction caused by a user redirecting the portable device 16). By analyzing the positioning data and the one of the boundaries indicated in the map in response to the acceleration (e.g., only in response to or following the acceleration), the processor 34 may conserve processing power and resources (e.g., instead of continuously analyzing the positioning data and the map).

In an embodiment, the additional components 22 may also include one or more feedback devices, such as one or more light emitters, one or more haptic devices, one or more displays, and/or one or more speakers. The one or more feedback devices of the portable device 16 may provide various types of feedback (e.g., special effects) to the guest 12 based on the interaction between the portable device 16 and interactive elements in the interactive environment 14. Additionally or alternatively, the one or more feedback devices may provide respective feedback as alerts, such as alerts that maintenance is approaching and/or due for the portable device 16.

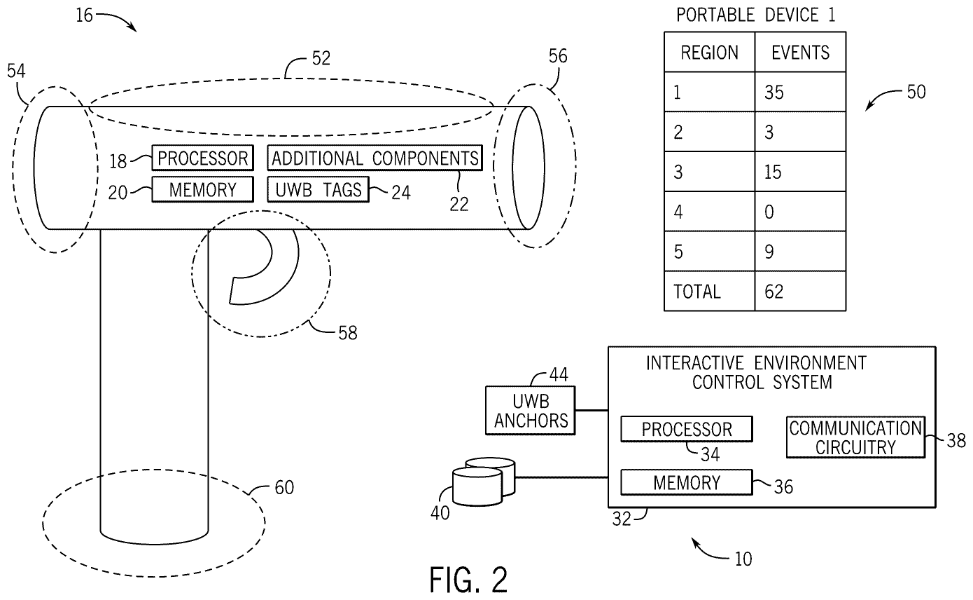

FIG. 2 is a schematic diagram of the portable device 16 with a form of a handheld portable device and a respective impact profile 50 for the portable device 16, in accordance with present embodiments. As shown, the portable device 16 may be divided into or described with reference to different regions. In FIG. 2, the portable device 16 includes a first region 52, a second region 54, a third region 56, a fourth region 58, and a fifth region 60. However, the portable device 16 may have any number of regions in any locations, such as 2, 3, 4, 5, 6, 7, 8, or more regions distributed about the portable device 16. Further, the different regions may be established or set based on a geometry and/or construction of the portable device 16, historical data related to impact events, modeled data indicative of possible or likely impact events, or any combination thereof.

As described herein, the control system 32 may track impact events for the portable device 16. For example, the processor 34 may analyze the positioning data generated by the UWB circuitry, analyze the acceleration data generated by the IMU, and/or reference the map of surfaces in the interactive environment. The processor 34 may determine that the portable device 16 has a particular orientation during an impact event with a boundary (e.g., at initial contact with the boundary), and thus, the processor 34 may determine that a particular region of the portable device 16 made contact with the boundary during the impact event. Then, the processor 34 may count the impact event for the particular region, such as by adding one impact event to a total tracked quantity of occurrences of impact events for the particular region. For example, if the processor 34 determines that the portable device 16 is inverted upon impact with a floor, the processor 34 may determine that the first region 52 of the portable device 16 made contact with the floor during the impact event. Then, the processor 34 may add one impact event to the total tracked quantity of occurrences of impact events for the first region 52 (e.g., from 34 to 35 impact events, as shown). In an embodiment, the processor 34 may also track a total tracked quantity of occurrences of impact events for the portable device 16, and thus, may add one impact event to the total tracked quantity of occurrences of impact events for the portable device 16 (e.g., from 61 to 62 impact events, as shown). It should be appreciated that the processor 34 may also access the model of the portable device 16 to determine occurrence of the impact event for the portable device 16, as well as to determine the particular region of the portable device 16 that contacts the surface.

The processor 34 may generate and/or reference respective thresholds for the different regions of the portable device 16, as it is recognized that the different regions of the portable device 16 may have different susceptibility to damage and/or impacts at the different regions may have different effects on the portable device 16. For example, the portable device 16 may be capable of withstanding a first number (e.g., many, such as at least 50, 75, 100 or more) of impact events at the first region 52 (e.g., a solid metal housing region), while the portable device 16 may be damaged after a second number (e.g., few, such as no more than 4, 5, 10, or 20) of impact events at the second region 54 (e.g., a plastic frame around a display). Additionally or alternatively, metrics, such as forces, experienced by the different regions of the portable device 16 may also be tracked per impact event. For example, the portable device 16 may be capable of withstanding a first tracked quantity of occurrences of impact events (e.g., many, such as at least 50, 75, 100 or more) with a first force value at the first region 52, but may only be capable of withstanding a second tracked quantity of occurrences of impact events (e.g., few, such as no more than 1, 2, 3, 4, 5, 10, or 20) with a second force (e.g., higher than the first force value; higher in magnitude) value at the first region 52. Accordingly, the processor 34 may generate (e.g., based on prior data, such as historical data and/or modeled data) and/or utilize respective thresholds for the different regions of the portable device 16. Further, in an embodiment, the processor 34 may consider the tracked quantity of occurrences of impact events and/or the metrics per impact event in comparison to respective thresholds and/or to assess whether a total tracked quantity of occurrences of events with or without the metrics reach an overall threshold for the portable device 16.

In an embodiment, the processor 34 or other suitable processing device may generate the respective thresholds for the different regions of the portable device 16. For example, the processor 34 or other suitable processing device may utilize historical data that indicates respective impact events for the different regions of the portable device 16, as well as associated operational data and/or maintenance data. The historical data may indicate prior instances in which the portable device 16 stopped functioning properly, as well as respective impact events for the different regions of the portable device 16 at a time at which the portable device 16 stopped functioning properly, which may inform appropriate respective thresholds for the different regions of the portable device 16. Additionally or alternatively, the historical data may indicate a condition of the portable device 16 at certain maintenance intervals, as well as respective impact events for the different regions of the portable device 16 prior to the maintenance intervals, which may inform appropriate respective thresholds for the different regions of the portable device 16. For example, if an operator inspects the portable device 16 at a maintenance interval and identifies a crack in a plastic frame in the second region 54 of the portable device 16, the operator may provide an input of damage at the second region 54. Then, the processor 34 may reference a respective tracked quantity of occurrences of impact events in the second region 54 prior to the maintenance interval and set the respective threshold for the second region 54 to be lower than the respective tracked quantity of occurrences of impact events in the second region 54 prior to the maintenance interval.

It should be appreciated that the maintenance intervals may include operator inspection and/or machine inspection, such as imaging devices and techniques to assess damage to the portable device 16, testing equipment that provides test signals and monitor responses from the portable device 16, and so forth. Further, the respective thresholds may include a portable device threshold that relates to or sets an acceptable tracked quantity of occurrences of impact events for the portable device 16. Additionally, the respective thresholds may be determined using machine learning techniques, such as artificial intelligence algorithms. In such cases, the historical data and/or the modeled data may be utilized as training data to determine the respective thresholds. Further, additional data related to the impact events, damage, and so forth may be utilized as training data to update the respective thresholds. In an embodiment, the machine learning techniques may also be utilized to determine different combinations of impact events at the different regions that warrant an alert to perform the maintenance operations. For example, there may be situations in which none of the different regions of the portable device 16 exceed the respective thresholds, but the combination of impact events at the different regions warrants an alert to perform the maintenance operations (e.g., multiple regions are close to the respective thresholds; the combination has resulted in damage according to the training data, such as the historical data). It should be appreciated that the historical data from the portable device 16 may be utilized to determine the respective thresholds for other portable devices, and similarly the historical data from other portable devices may be utilized to determine the respective thresholds for the portable device 16. Thus, the impact detection system 10 may facilitate efficient removal and maintenance of any portable device that may be damaged due to being improperly handled and may facilitate operation of the interactive environment so that the guests are able to experience the interactive environment with functioning portable devices.

As noted herein, over time, the impact detection system 10 may build and generate the respective impact profile 50 for the portable device 16, as well as respective impact profiles for other portable devices. In this way, an operator may request and/or access respective impact profiles for multiple portable devices, which may facilitate maintenance operations for the multiple portable devices. Further, the respective impact profiles for the multiple portable devices may be utilized to inform design, construction, and/or maintenance for the multiple portable devices and future versions of portable devices.

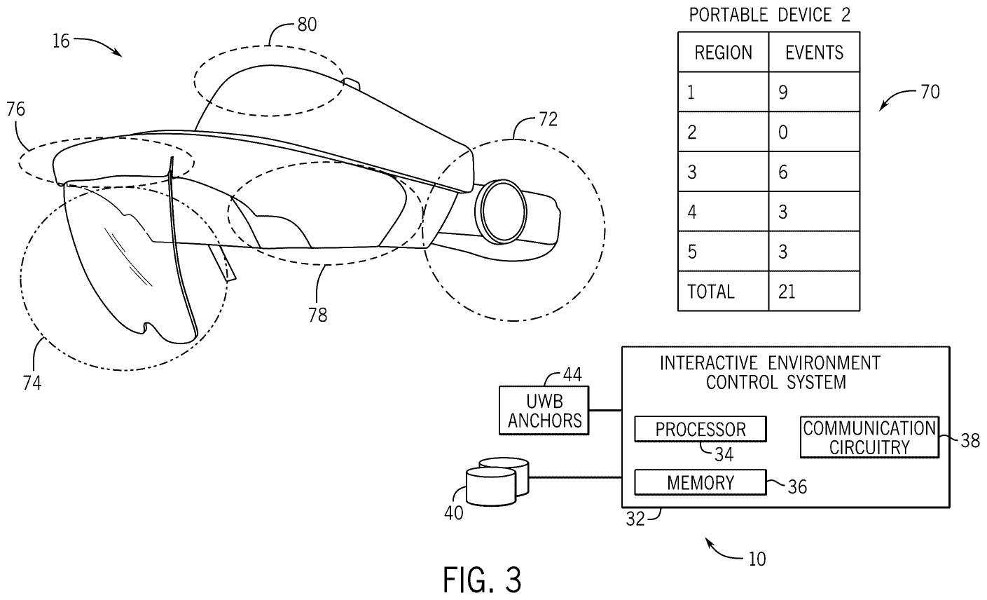

FIG. 3 is a schematic diagram of the portable device 16 with a form of a wearable portable device and a respective impact profile 70 for the portable device 16, in accordance with present embodiments. In FIG. 3, the wearable portable device includes augmented reality (AR) and/or virtual reality (VR) glasses that are configured to be worn on a head of the guest to present virtual imagery to the guest. Thus, the wearable portable device may include an interface device that wraps around the head of the guest, and one or more display surfaces that present the virtual imagery to the guest. As shown, the portable device 16 may be divided into or described with reference to different regions. In FIG. 3, the portable device 16 includes a first region 72, a second region 74, a third region 76, a fourth region 78, and a fifth region 80. However, the portable device 16 may have any number of regions in any locations, such as 2, 3, 4, 5, 6, 7, 8, or more regions distributed about the portable device 16.

As described herein, the control system 32 may track impact events for the portable device 16. For example, the processor 34 may analyze the positioning data generated by the UWB circuitry, analyze the acceleration data generated by the IMU, and/or reference the map of surfaces in the interactive environment. The processor 34 may determine that the portable device 16 has a particular orientation during an impact event with a boundary, and thus, the processor 34 may determine that a particular region of the portable device 16 made contact with the boundary during the impact event. Then, the processor 34 may count the impact event for the particular region, such as by adding one impact event to a total tracked quantity of occurrences of impact events for the particular region. In an embodiment, the processor 34 may also track a total tracked quantity of occurrences of impact events for the portable device 16.

The processor 34 may generate and/or reference respective thresholds for the different regions of the portable device 16. For example, the portable device 16 may be capable of withstanding a first number (e.g., many, such as at least 10, 20, 50, or more) of impact events at the first region 72 (e.g., the interface device), while the portable device 16 may be damaged after a second number (e.g., few, such as no more than 1, 2, or 3) of impact events at the second region 74 (e.g., the one or more display surfaces). Accordingly, the processor 34 may generate (e.g., based on prior data, such as historical data and/or modeled data) and/or utilize respective thresholds for the different regions of the portable device 16. As described herein, the processor 34 or other suitable processing device may generate the respective thresholds for the different regions of the portable device 16. Further, the respective thresholds may include a portable device threshold that relates to or sets an acceptable tracked quantity of occurrences of impact events for the portable device 16. Additionally, the respective thresholds may be determined using machine learning techniques, such as artificial intelligence algorithms.

As noted herein, over time, the impact detection system 10 may build and generate the respective impact profile 70 for the portable device 16, as well as respective impact profiles for other portable devices. It should be appreciated that the impact detection system 10 may build and generate the respective profiles for different types of portable devices, such as handheld targeting devices, wearable devices, and so forth.

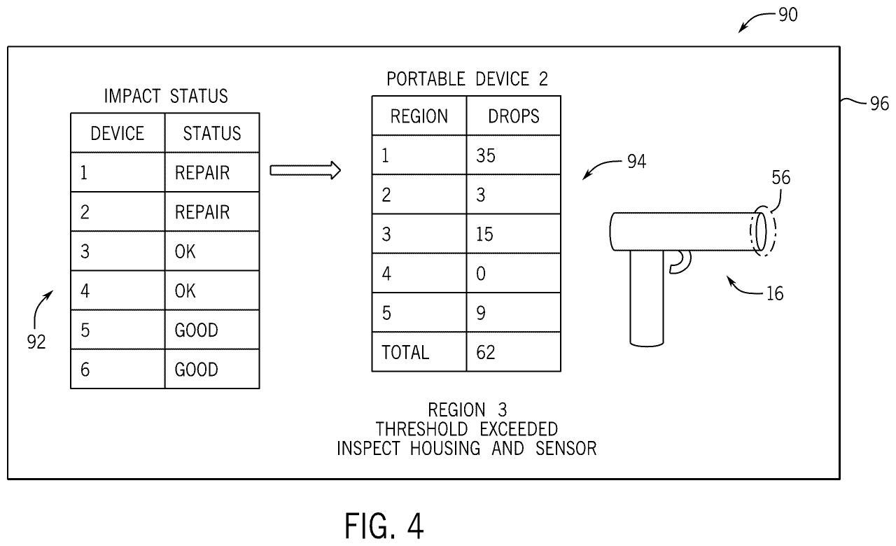

FIG. 4 is an example of a graphical user interface (GUI) 90 that presents a table 92 with respective impact statuses for multiple portable devices and a respective impact profile 94 for one portable device of the multiple portable devices, in accordance with present embodiments. For example, the one portable device of the multiple portable devices may be the portable device 16 of FIG. 2. The GUI 90 may be presented on a display 96 (e.g., display screen), which may be part of or communicatively coupled to the control system 32 of FIG. 1. For example, the display 96 may be part of an operator work station, which may be located in a maintenance area associated with the interactive environment or in any other suitable area. Further, the display 96 may be part of a portable work station, such as a tablet computer that may be carried by an operator.

As shown, the GUI 90 may include the table 92 with the respective impact statuses for the multiple portable devices, and the table 92 may include any of a variety of types of information. For example, the table 92 may include a respective identifier for each of the multiple portable devices, as well as the respective statuses with respect to maintenance. The respective statuses may include text indicators such as “REPAIR,” “OK,” “GOOD,” and so forth. In some cases, the respective statuses may include numerical indicators, such as on a scale of one to ten, with one indicating a need for removal for maintenance and ten indicating no or few impact events. In some cases, the respective statuses may include numerical indicators, wherein the numerical indicators are a total tracked quantity of occurrences of impact events. For example, the table 92 may indicate the numerical indictor “62” instead of or in addition to the text indicator “REPAIR.” In any case, the table 92 may provide a summary of the respective statuses for the multiple portable devices in a format that is easy to read and understand. In an embodiment, the table 92 may be color coded or provide other visual features to facilitate identification of the multiple portable devices that should be obtained or pulled for maintenance operations. Further, entries in the table 92 may be sorted, filtered, or both based on the respective statuses and/or any other factors, such as device type. Indeed, the operator may provide inputs (e.g., the display 96 may be a touchscreen display) that enable the operator to sort, filter, or both, the entries in the table 92 according to preferences or to complete particular tasks.

In an embodiment, the respective impact profile 94 may be presented upon selection of the portable device 16 in the table 92. The respective impact profile 94 may include detailed information about the impact events for the portable device 16, such as a respective tracked quantity of occurrences of impact events for each of the different regions of the portable device 16. In an embodiment, additional visual indicators may be provided to facilitate understanding and/or maintenance by the operator, such as bold font and/or a text message to highlight that the respective total tracked quantity of occurrences of impact events for the third region 56 has exceeded the respective threshold for the third region 56. In an embodiment, a visual representation of the portable device 16 may be provided via the GUI 90, and the visual representation may include a marker to surround or label the third region 56 and/or areas that should be inspected as art of the maintenance operations, which may facilitate inspection and repair by the operator.

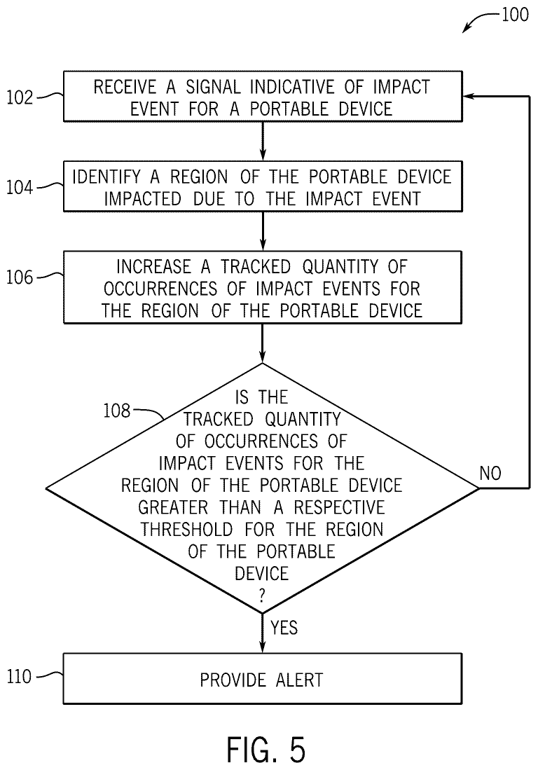

FIG. 5 is a flow diagram of a method 100 of operating an impact detection system, such as the impact detection system 10 of FIG. 1, to assess a number of impact events in a region of a portable device, in accordance with present embodiments. The method 100 includes various steps represented by blocks. It should be noted that at least some steps of the method 100 may be performed as an automated procedure by a processing system, such as the control system 32 of FIG. 1. Although the flow chart illustrates the steps in a certain sequence, it should be understood that the steps may be performed in any suitable order and certain steps may be carried out simultaneously, where appropriate. Additionally, steps may be added to or omitted from the method 100.

In block 102, the processing system may receive a signal indicative of an impact event for a portable device. The signal may include or indicate positioning data obtained via UWB circuitry, such as UWB tags on the portable device and UWB readers in an interactive environment. In an embodiment, the processing system may access and reference a map of the interactive environment, wherein the map represents or indicates locations of boundaries within the interactive environment. For example, the map may represent or indicate the locations of a floor, a ceiling, and/or side walls according to a coordinate system, such as a local coordinate system for the interactive environment. Thus, the processing system may compare a position of the portable device with respect to the coordinate system and based on the signal that includes or indicates the positioning data obtained via the UWB circuitry to the locations of the boundaries within the interactive environment. If the position of the portable device overlaps with, intersects with, and/or corresponds to a respective location of one of the boundaries within the interactive environment, then the processing system may identify contact between the portable device and the one of the boundaries within the interactive environment.

In block 104, the processing system may identify a region of the portable device impacted due to the impact event. For example, the processing system may process the positioning data obtained via the UWB circuitry to determine an orientation of the portable device upon the contact between the portable device and a boundary of the boundaries within the interactive environment. Further, the processing system may determine the region of the portable device that contacts the boundary based on the orientation of the portable device during the contact with the boundary.

As described herein, the processing system may also obtain other signals and/or data, such as acceleration data from an IMU of the portable device, to identify occurrence of the impact event and/or to identify the region of the portable device that experiences contact with the boundary during the impact event. For example, it should be appreciated that the acceleration data may indicate acceleration for the portable device exceeds an acceleration threshold. This may trigger or cause the processing system to initiate block 102 to proceed with evaluation of the positioning data and the map, such as at limited times proximate to a time at which the acceleration for the portable device exceeds the acceleration threshold or otherwise indicates impact (e.g., acceleration constant due to gravity or high due to handling by the guest, and then reaches zero; corresponds to acceleration signature associated with or indicative of impact). In an embodiment, the processing system may carry out more complex evaluation of the acceleration data, such as via machine learning algorithms to determine that the acceleration (e.g., acceleration signature or pattern) likely corresponds to impact with a surface. Then, this may trigger or cause the processing system to initiate block 102 to proceed with evaluation of the positioning data and the map, such as at limited times proximate to a time at which the acceleration for the portable device indicates impact. Further, the processing system may consider the orientation at the time at which the acceleration indicates impact to determine the region of the portable device impacted due to the impact event, as set forth in block 104.

In block 106, the processing system may increase a respective tracked quantity of occurrences of impact events for the region of the portable device. For example, the respective tracked quantity of occurrences of impact events for the region of the portable device may increase by one. Further, a total tracked quantity of occurrences of impact events for the portable device may also increase by one.

In block 108, the processing system may compare the respective tracked quantity of occurrences of impact events for the region of the portable device to a respective threshold for the region of the portable device. For example, this may include comparing the respective tracked quantity of occurrences of impact events. If the respective tracked quantity of occurrences of impact events for the region of the portable device does not exceed the respective threshold for the region of the portable device, the method 100 may return to block 102 to continue monitoring for additional impact events. However, if the respective tracked quantity of occurrences of impact events for the region of the portable device exceeds the respective threshold for the region of the portable device, the method 100 may continue to block 110.

In block 110, the processing system may generate or provide an alert. The alert may indicate that maintenance operations should be carried out for the portable device, such as inspection, repair, and so forth for the portable device. The alert may include an audible alert, a visual alert, or both. The alert may be provided via respective components of the portable device, via respective components off-board or separate from the portable device, or both. For example, the alert may include an audible alarm provided via a speaker of the portable device and/or a visual alert provided via a display of the portable device. Additionally or alternatively, the alert may include an audible alarm provided via a speaker of an operator work station and/or a visual alert provided via a display of the operator work station. In an embodiment, the alert may not be provided via the portable device while the portable device is in use by a guest in the interactive environment, so as not to detract from an interactive experience. Although it should be appreciated that the alert may be provided via the portable device and/or via other systems at any time after the processing system determines that the alert should be provided and/or that maintenance operations should be carried out for the portable device based on the impact event(s).

As described herein, the processing system may determine that the alert should be provided based on other factors, such as certain high force impact events or various combinations of impact events at different regions that are predicted or are likely to damage the portable device, for example. Thus, it should be appreciated that the block 108 may include another assessment or decision, such as an assessment of a respective impact profile for the portable device. The respective impact profile for the portable device may include respective impact events for the different regions of the portable device, the total tracked quantity of occurrences of impact events for the portable device, and so forth. In this way, the processing system may determine that the alert should be provided based on combinations of impact events, as an interior component of the portable device may be negatively affected by impacts at two or more regions of the portable device. In such cases, the processing system may determine that the alert should be provided due to a sum of the impacts at the two or more regions of the portable device exceeding a threshold.

In some cases, the respective impact profile for the portable device may include additional information, such as acceleration over time, position over time, orientation over time, and so forth for some time period before and/or after each impact event. Further, the additional information may include impact force and/or velocity at a time of impact for each impact event. In some cases, the respective impact profile for the portable device may also indicate or account for features of the boundary (e.g., a material, a hardness, or other physical characteristics of the boundary), such as by counting respective events per type of boundary, applying weighting factors based on the features of the boundary (e.g., via counting, such as one impact event on a concrete surface counts as two impact events, and one impact event on a carpeted surface counts as one impact events; via inputs to machine learning algorithms), and so forth. The processing system may be configured to evaluate various combinations of information to determine that the alert should be provided and/or that the maintenance operations should be carried out for the portable device based on the impact event(s). For example, the processing system may implement machine learning techniques with machine learning algorithms trained with training data to assess the various combinations of information to determine that the maintenance operations should be carried out for the portable device based on the impact event(s), to set the respective thresholds, and so forth. It should be appreciated that the method 100 may be carried out for multiple portable devices simultaneously and over time, such that the processing system effectively and efficiently monitors respective health and maintenance statuses for the multiple portable devices. Further, the method 100 may be carried out for multiple portable devices in real time (e.g., substantially real time), including while the multiple portable devices are carried by guests through the interactive environment.

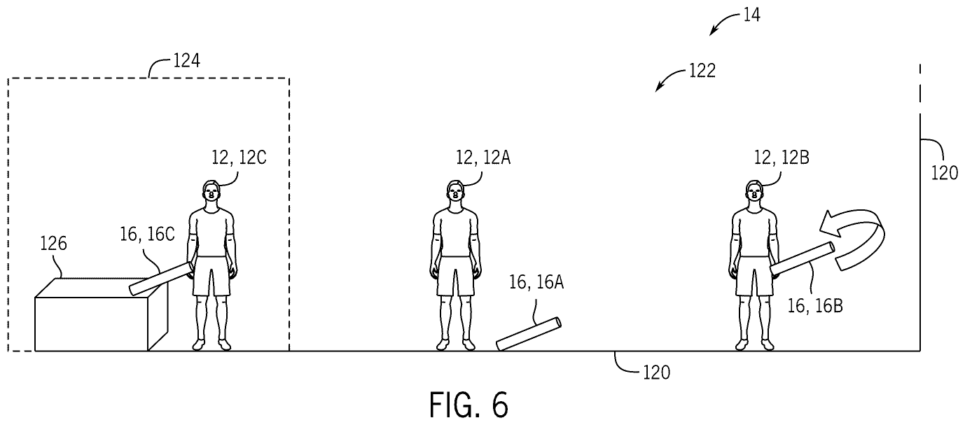

FIG. 6 illustrates guests 12 with portable devices 16 within the interactive environment 14 with one or more impact detection boundaries 120 and one or more impact detection zones 122, in accordance with present embodiments. The impact detection zones 122 may be areas of the interactive environment 14 in which impact events are tracked for the portable devices 16. For example, the impact detection zones 122 may include interactive areas of the interactive environment 14, such as interactive areas in which the guests 12 use (e.g., move) the portable devices 16 to interact with features of the interactive environment 14. As shown, the guests 12 may include a first guest 12A, a second guest 12B, and a third guest 12C. The first guest 12A has or is associated with a first portable device 16A, the second guest 12B has or is associated with a second portable device 16B, and the third guest 12C has or is associated with a third portable device 16C.

In operation, the first guest 12A may carry the first portable device 16A into the one or more impact detection zones 122 of the interactive environment 14. The first guest 12A may move the first portable device 16A to interact with interactive elements in the interactive environment 14. However, the first guest 12A may drop the first portable device 16A onto a floor that is one of the one or more impact detection boundaries 120, such as inadvertently due to losing grip on the first portable device 16A or for various other reasons. In such cases, the impact detection system described herein may identify an impact event for the first portable device 16A. In particular, the impact detection system may receive a signal from UWB circuitry, acceleration data from an IMU of the first portable device 16, and/or other data. The impact detection system may also access the map that indicates coordinates of the floor, and the impact detection system may compare a position and orientation of the first portable device 16A to the coordinates of the floor to determine that a particular region of the first portable device 16A contacted with the floor. Then, the impact detection system may update the respective impact profile for the first portable device 16A and carry out other actions as described herein.

As shown, the second guest 12B may carry the second portable device 16B into the one or more impact detection zones 122 of the interactive environment 14. The second guest 12B may move the second portable device 16B to interact with the interactive elements in the interactive environment 14. However, the second guest 12B may wave the second portable device 16B, which may cause positioning data and/or acceleration data to mimic or appear as an impact event. For example, the acceleration data may indicate sudden changes in acceleration and/or acceleration values (e.g., over an acceleration threshold; high acceleration followed by no acceleration; acceleration signatures or patterns) that are similar to those observed during the impact events. In such cases, in response to the acceleration data, the impact detection system may access the map that indicates coordinates of the one or more impact detection boundaries 120, and the impact detection system may compare a position and/or an orientation of the second portable device 16B to the coordinates of the one or more impact detection boundaries 120 to determine that the second portable device 16B did not contact any of the one or more impact detection boundaries 120. Accordingly, the impact detection system may not update a tracked quantity of occurrences of impact events in the respective profile for the second portable device 16B. It should be appreciated that the impact detection system may separately count such accelerations as non-impact events (e.g., acceleration events; separately count and record from the impact events in the respective profile for the second portable device 16B). This may be useful as certain portable devices may experience damage due to such accelerations, even without impact.

Further, the impact detection system may use machine learning algorithms to analyze the acceleration data (e.g., acceleration signatures or patterns) to determine occurrence of impact events, including impact events with movable or non-stationary boundaries, such as the portable devices 16. For example, the impact events may include such impact events due to the second portable device 16B striking another portable device, a shoe of the second guest 12B, or some other surface that is not represented in the map. Indeed, in certain cases, the impact detection system may use the machine learning algorithms to analyze the acceleration data to determine the occurrence of the impact event after concluding that the second portable device 16B did not contact any of the one or more impact detection boundaries 120. Thus, the acceleration data for the second portable device 16B may trigger reference to the map. However, if it is determined that the second portable device 16B did not contact any of the one or more impact detection boundaries 120, then this may trigger further detailed analysis of the acceleration data with the machine learning algorithms to determine the occurrence of the impact event between the second portable device 16B and one of the movable or non-stationary boundaries. In an embodiment, a position and/or an orientation of the movable or non-stationary boundaries may be tracked and updated in the map over time (e.g., continuously or periodically; based on data as described herein).

It should be appreciated that the impact detection system may separately count such impact events with the movable or non-stationary boundaries (e.g., separately count and record the impact event in the respective profile for the second portable device 16B). This may be useful as certain portable devices may experience damage due to such impact events. Indeed, as such impact events and associated damage may not be well known (e.g., not part of empirical or historical data; difficult to categorize or assess severity), the impact detection system may provide an alert to prompt inspection of the second portable device 16B in response to the impact event (e.g., the alert instructs the operator to pull the second portable device 16B for inspection, such as after the second portable device 16B is returned by the second guest 12B at a conclusion of passage through the interactive environment 14). Further, the impact detection system may determine the orientation of the second portable device 16B at a time of impact with a movable or non-stationary surface during the impact event, and thus, the impact detection system may determine a particular region of the second portable device 16B that experienced impact or contact with the movable or non-stationary surface during the impact event. Accordingly, the respective profile for the second portable device 16B may also include the impact event, along with or in association with the impact at the particular region, as described herein.

It should be appreciated that the impact detection system may consider other types of data in assessment of non-impact events and impact events, and particularly with respect to impact events due to contact with the movable or non-stationary surface. For example, the other types of data may include the position data, the orientation data, the velocity data, and/or environment data, such as images of the interactive environment 14, as inputs into the machine learning algorithms (e.g., with computer vision to assess the images) to determine the occurrence of the impact event. Further, while certain examples describe analysis of the acceleration data to determine the occurrence of the impact event after concluding that the second portable device 16B did not contact any of the one or more impact detection boundaries 120, it should be appreciated that a more thorough assessment of the acceleration data (and/or the other type of data) may be carried out prior to analysis of the position of the second portable device 16B relative to the map to determine whether the second portable device 16B contacted any of the one or more impact detection boundaries 120. That is, a complete or thorough assessment and analysis of the acceleration data may be completed (e.g., at least based on the acceleration data; the acceleration signatures or patterns; to identify impact at some surface versus swift motion in space without impact; using machine learning algorithms) prior to assessment of boundary impact events (e.g., with the map).

In operation, the third guest 12C may move the third portable device 16C to interact with the interactive elements in the interactive environment 14. At a conclusion of an interactive experience, the third guest 12C may travel from the impact detection zone 122 into an exchange zone 124 to deposit or return the third portable device 16C for use by another guest (e.g., at a later time, after cleaning). The exchange zone 124 may generally include an area in which the portable devices 16 are transferred to the guests 12 and/or transferred from the guests 12. For example, the exchange zone 124 may include a portion of a queue for entry to the interactive environment 14, an exit path from the interactive environment 14, and so forth. In an embodiment, the exchange zone 124 may include a container 126 that holds multiple portable devices 16 for pick up by the guests 12, for drop off from the guests 12, and so forth. It should be appreciated that the container 126 may include a box, a conveyor, or any other suitable component(s) to facilitate transfer of the portable devices 16 to and/or from the guests 12.

Thus, the third guest 12C may drop or place the third portable device 16C into the container 126. For example, placing the third portable device 16C into the container 126 may result in acceleration data that indicates impact, but the impact detection system may not proceed with processing to determine or to count impact events due to positioning data indicating that the third portable device 16C is within the exchange zone 124 during the impact. In some such cases, the impact detection system may access the map that indicates coordinates of the exchange zone 124, and the impact detection system may compare a position of the third portable device 16C to the coordinates of the exchange zone 124 to determine that the third portable device 16C is within the exchange zone 124. Accordingly, the impact detection system may not update a tracked quantity of occurrences of impact events in the respective profile for the third portable device 16C, or the impact detection system may separately record events within the exchange zone 124 in the respective profile for the third portable device 16C.

Accordingly, it may be desirable not to monitor for impact events in the exchange zone 124, or to separately count events within the exchange zone 124 that otherwise would be determined to be impact zone events if they occurred outside of the exchange zone 124 and in the impact detection zone 122 (e.g., separately count from the impact events that occur in the impact detection zone 122). For example, it may be expected that the acceleration data will indicate that the portable devices 16 are dropped into the container 126, and thus it may be more efficient from a processing perspective not to track these events within the exchange zone 124 via analysis of the positioning data, the acceleration data, and/or the map, for example. Further, it is expected that impact forces due to the portable devices 16 being dropped into the container 126 are minor and unlikely to affect functionality of the portable devices 16. Further, a number of events within the exchange zone 124 can be counted or estimated by counting a respective number of uses of the portable devices 16, without more complex processing via analysis of the positioning data, the acceleration data, and/or the map, for example. However, it may be desirable to separately monitor and count the events within the exchange zone 124 via analysis of the positioning data, the acceleration data, and/or the map, as described herein. This may assist with accounting for unusual events within the exchange zone 124, such as where the guests throw the multiple portable device 16 at high velocity, where the multiple portable devices 16 land in particularly fragile regions, and so forth. In such cases, the control system 32 may assess the respective impact profiles for the multiple portable devices 16, including both the impact events in the one or more impact detection zones 122 and the events within the exchange zone 124, to determine whether maintenance should be completed. The control system 32 may implement machine learning techniques to assess the respective impact profiles for the multiple portable devices 16, as described herein.

Embodiments may use machine learning algorithms to establish learned relationships between inputs and outputs. Rather than using conversion equations, the machine learning algorithms may learn many relationships that may not be readily apparent to a human observer. Trained machine learning algorithms can improve result accuracy, particularly for conditions that are not well quantified through conversion equations.

It should be appreciated that features shown in FIGS. 1-6 and described with reference to FIGS. 1-6 may be combined in any suitable manner. Further, as described herein, UWB circuitry may be utilized to determine position, orientation, acceleration, and/or velocity. Thus, it should be appreciated that UWB circuitry may be used instead of IMUs in any examples that refer to use of IMUs to determine position, orientation, acceleration, and/or velocity.

It is presently recognized that an impact detection system, such as the impact detection system 10, may monitor impact events for one or more components in an interactive environment, such as the interactive environment 14. For example, the one or more components may include a physical interactive element, a camera, a speaker, a display, a communication device, a sensor, a gate, a rail (e.g., handrail), a door, a ride vehicle, a container, any other component, or any combination thereof. For example, the one or more components may include a contact sensor coupled to or integrated with a rail to detect contact or impact at the rail. Indeed, the one or more components may include any electrical, mechanical, and/or decorative object. Further, the one or more components may include stationary or fixed structures, such as fixed UWB anchors or fixed displays. The one or more components may include movable structures, such as movable physical interactive elements and/or movable ride vehicles.

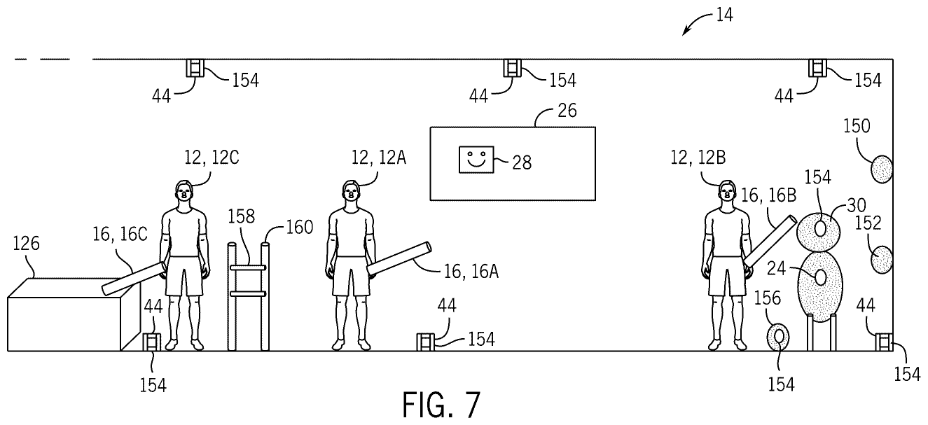

With the foregoing in mind, FIG. 7 illustrates the guests 12 within the interactive environment 14 with one or more components, in accordance with present embodiments. In an embodiment, the guests 12 may carry portable devices 16 through the interactive environment 14. As shown, the guests 12 may include the first guest 12A, the second guest 12B, and the third guest 12C. The first guest 12A has or is associated with the first portable device 16A, the second guest 12B has or is associated with the second portable device 16B, and the third guest 12C has or is associated with the third portable device 16C. As described herein, the impact detection system may be configured to detect and record respective impact events for the one or more components. To facilitate discussion, certain examples of possible impact events that may be detected and recorded are described herein.

In an embodiment, the first guest 12A may operate the first portable device 16A to interact with and/or to move about the one or more components, as described herein. For example, the first guest 12A may move the first portable device 16A to interact with the virtual interactive elements 28 presented on the display 26. In certain circumstances, the first guest 12A may move the first portable device 16A incorrectly and/or may be too close to the display 26, such that the first portable device 16A may contact the display 26. In such cases, the impact detection system may identify an impact event for the display 26.

In an embodiment, the impact detection system may receive a signal from UWB circuitry, acceleration data from an IMU of the first portable device 16A, and/or other data, such as a map of the interactive environment 14 that includes a respective location (e.g., coordinates) of the display 26 (e.g., as one boundary). The impact detection system may compare a position of the first portable device 16A to the respective location of the display 26 to determine that the first portable device 16A contacted the display 26. Thus, in this case, the impact detection system may effectively consider the display 26 to be one of the one or more boundaries of the interactive environment 14, and the impact detection system may operate to detect the impact event at the display 26 with the display 26 as one of the one or more boundaries, as described herein.

Then, the impact detection system may update a respective impact profile for the display 26 to count the impact event for the display 26 and to carry out other actions, such as to provide an alert. For example, in such cases, the impact detection system may compare a total tracked quantity of occurrences of impact events for the display 26 to a respective threshold for the display 26, and provide the alert in response to the total tracked quantity of occurrences of impact events for the display 26 exceeding the respective threshold for the display 26. The respective threshold may relate to or set an acceptable tracked quantity of occurrences of impact events for the display 26.

It should be appreciated that, in certain embodiments, the impact detection system may be triggered to compare the position of the first portable device 16A to the respective location of the display 26 based on an acceleration of the first portable device 16A (e.g., the acceleration of the first portable device 16A exceeds a threshold or otherwise indicates impact). Additionally or alternatively, the display 26 may include or be coupled to sensors (e.g., impact sensors) that detect contact at the display 26.

In an embodiment, the impact detection system may be configured to determine a region of the display 26 that is contacted during the impact event (e.g., a frame, a portion of the frame, a display panel, a portion of the display panel). Additionally or alternatively, the impact detection system may be configured to determine a region of the first portable device 16A (e.g., a first region, a second region, a third region, and so on) that contacted the display 26. The impact detection system may make such determinations based on the position and/or the orientation of the first portable device 16 during the impact event at the display 26. This may be advantageous as certain portions of the display 26 may be more susceptible to damage, and also certain portions of the first portable device 16 may be more likely to cause damage. For example, a curved plastic handle of the first portable device 16 may be unlikely to scratch the display panel, while a narrow tip of the first portable device 16 may be more likely to scratch the display panel.

In such cases, the impact detection system may update the respective impact profile for the display 26 by recording the impact event for the region of the display 26. As described herein, the impact event may be stored or categorized in association with the region of the display 26 that is contacted during the impact event (e.g., increase a count of impacts for the region). Further, the impact event may be stored or categorized with other information, such as the portion of the first portable device 16A that contacted the display 26 during the impact event.

Further, in such cases, the impact detection system may also compare a total tracked quantity of occurrences of impact events for the region of the display 26 to a respective threshold for the region, and provide an alert in response to the total tracked quantity of occurrences of impact events for the region of the display 26 exceeding the respective threshold for the region. In this way, the impact detection system may track impact events for the display 26, including on a region-by-region basis and in a similar manner as described herein for the portable devices. Indeed, techniques to track, monitor, record, and/or alert for the impact events at the display 26 and other components may include any of the features described herein with respect to the portable devices. The respective threshold may relate to or set an acceptable tracked quantity of occurrences of impact events for the region of the display 26.

The respective threshold may be determined using machine learning techniques, such as artificial intelligence algorithms. In such cases, historical data and/or modeled data may be utilized as training data to determine the respective threshold(s) for the display 26 and/or the different regions of the display 26. Further, additional data related to the impact events, damage, and so forth may be utilized as training data to update the respective threshold(s). In an embodiment, the machine learning techniques may also be utilized to determine different combinations of impact events at the different regions that warrant an alert to perform the maintenance operations. For example, there may be situations in which none of the different regions of the display 26 exceed the respective thresholds, but the combination of impact events at the different regions warrants an alert to perform the maintenance operations (e.g., multiple regions are close to the respective thresholds; the combination has resulted in damage according to the training data, such as the historical data). It should be appreciated that the historical data from the display 26 may be utilized to determine the respective thresholds for other displays, and similarly the historical data from other displays may be utilized to determine the respective thresholds for the display 26.

Over time, the impact detection system may build and generate the respective impact profile for the display 26, as well as respective impact profiles for other displays and/or components in the interactive environment 14. In this way, an operator may request and/or access respective impact profiles for multiple components, which may facilitate maintenance operations for the multiple components. Further, the respective impact profiles for the multiple components may be utilized to inform design, construction, and/or maintenance for the multiple components and future versions of multiple components. The respective impact profiles for the multiple components may also be utilized to inform, design, construction, and/or maintenance for the interactive environment 14 and/or future interactive environments. For example, the respective impact profile for the display 26 may indicate repeated contact at a lower left portion of the frame of the display 26. Accordingly, the impact detection system may indicate or recommend (e.g., text output) that the display 26 be modified or that portions of the interactive environment 14 be modified, such as by moving the display 26 to another location, adjusting content shown on the display 26, installing barriers in front of the display26, and so forth.

The impact detection system may track and record impact events for any of a variety of components within the interactive environment 14, such as stationary components, moving components, electrical components, mechanical components, decorative components, and so forth. For example, the impact detection system may track and record impact events for one or more displays 26, one or more physical interactive elements 30, one or more cameras 150, one or more speakers 152, one or more communication devices such as the UWB anchors 44, one or more sensors 154, one or more light sources 156, one or more gates 158, one or more rails 160, one or more containers such as the container 126, one or more doors, one or more ride vehicles, any other component, or any combination thereof. The impact detection system may track and record respective impact events for any of the one or more components present in the interactive environment 14, as set forth herein with respect to the display 26. Further, the impact detection system may track and record the respective impact events for each region of any of the components present in the interactive environment 14, as set forth herein with respect to the display 26. In this way, the impact detection system may track and monitor a health or status of the one or more components, provide appropriate alerts to facilitate maintenance, and provide appropriate information to facilitate construction (or reconstruction) or design (or redesign) of the interactive environment 14 based on the respective impact events for the one or more components.

As another example, the second guest 12B may operate the second portable device 16B to interact with and/or to move about the one or more components. For example, the second guest 12B may move the second portable device 16B to interact with the physical interactive elements 30. However, the second guest 12B may wave the second portable device 16B in a manner that causes the second portable device 16B to contact the physical interactive element 30. The impact detection system may detect and record the impact event for the physical interactive element 30.

The physical interactive element 30 may be configured to move within the interactive environment 14, such as to walk along a pathway in the interactive environment 14. In an embodiment, the physical interactive element 30 may be controlled to move with defined motions, locations, and timing. In such cases, the impact detection system may update the map based on the defined motions, locations, and timing, or the impact detection system may access the map that reflects a current position of the physical interactive element 30 as the second guest 12B interacts with the physical interactive element 30. In an embodiment, the motions and/or locations of the physical interactive element 30 may be monitored via the UWB circuitry, such as via the UWB tags 24 coupled to the physical interactive element 30. Additionally or alternatively, the motions and/or locations of the physical interactive element 30 may be monitored via a respective sensor 154 coupled to the physical interactive element 30 and/or the camera 150 positioned to capture images of the physical interactive element 30, for example. In an embodiment, the impact detection system may track respective coordinates of the physical interactive element 30 over time and/or may update the map to reflect the respective coordinates of the physical interactive element 30 over time.

The impact detection system may compare a position and/or an orientation of the second portable device 16B to the respective location of the physical interactive element 30 to determine that the second portable device 16B contacted the physical interactive element 30. Then, the impact detection system may update a respective impact profile for the physical interactive element 30 to count an impact event for the physical interactive element 30 and to carry out other actions, such as to provide an alert. For example, in such cases, the impact detection system may compare a total tracked quantity of occurrences of impact events for the physical interactive element 30 to a respective threshold for the physical interactive element 30, and provide the alert in response to the total tracked quantity of occurrences of impact events for the physical interactive element 30 exceeding the respective threshold for the physical interactive element 30. The respective threshold may relate to or set an acceptable tracked quantity of occurrences of impact events for the physical interactive element 30.

It should be appreciated that the impact detection system may determine a region of the physical interactive element 30 contacted by the second portable device 16B and may record the impact event for the region of the physical interactive element 30. Further, it should be appreciated that the impact detection system may be triggered to compare the position of the second portable device 16B to the respective location of the physical interactive element 30 based on an acceleration of the second portable device 16B, position data of the physical interactive element 30 that indicates unexpected motion of the physical interactive element 30, and/or sensor data from the sensor 154 that indicates impact at the physical interactive element 30.

As another example, the third guest 12C may operate the third portable device 16C to move the third portable device 16C toward the container 126 as the third guest 12C exits the interactive environment 14. However, the third guest 12C may contact one of the UWB anchors 44, which may be positioned on a floor or other surface of the interactive environment 14. For example, the third guest 12C may inadvertently kick the one of the UWB anchors 44 as they walk toward the container 126. In certain embodiments, the impact detection system may detect and record an impact event for the one of the UWB anchors 44, even if the impact event occurred due to contact with the third guest 12C or some object other than the portable devices.

In an embodiment, at least one of the UWB anchors 44 may include one or more respective sensors 154, which may detect one or more parameters indicative of an impact event. For example, the one or more respective sensors 154 may include position sensors, IMUs, accelerometers, impact sensors, or any combination thereof. Further, the one or more parameters may include position, acceleration, movement, force, contact, or any combination thereof. In response to detecting the one or more parameters indicative of the impact event, the impact detection system may record the impact event. In particular, the impact detection system may update a respective impact profile for the one of the UWB anchors 44 to count an impact event for the UWB anchors 44 and to carry out other actions as described herein, such as to provide an alert. For example, in such cases, the impact detection system may compare a total tracked quantity of occurrences of impact events for the one of the UWB anchors 44 to a respective threshold for the one of the UWB anchors 44, and provide the alert in response to the total tracked quantity of occurrences of impact events for the one of the UWB anchors 44 exceeding the respective threshold for the one of the UWB anchors 44. The respective threshold may relate to or set an acceptable tracked quantity of occurrences of impact events for the one of the UWB anchors 44.

In an embodiment, the impact detection system may track or record a region of the one of the UWB anchors 44 contacted during the impact event, which may indicate that the one of the UWB anchors 44 was contacted on a side surface as opposed to a top surface, for example. The impact detection system may determine the region of the one of the UWB anchors 44 contact during the impact event via any suitable technique, such as based on a direction of movement detected by the one or more respective sensors 154, impact detected at one of the one or more respective sensors 154 arranged in an array about the one of the UWB anchors 44, and so forth.

It should be appreciated that, in certain embodiments, detection of the impact event based on sensor data from the one or more respective sensors 154 of the one of the UWB anchors 44 may trigger the impact detection system to compare the position of the third portable device 16C to the respective location of the one of the UWB anchors 44 at a time of the impact event. In this way, the impact detection system may determine whether the third portable device 16C did or did not contact the one of the UWB anchors 44 during the impact event. In turn, this may indicate whether another object (e.g., the third guest 12C) did or did not contact the one of the UWB anchors 44 during the impact event. For example, if the third portable device 16C was not co-located with the one of the UWB anchors 44 at the time of the impact event, the impact detection system may determine that another object contacted the one of the UWB anchors 44 during the impact event. In certain cases, the impact detection system may access and analyze other information to identify a source of the impact event, such as image data from the camera 150, for example.

It may be advantageous to include the one or more respective sensors 154 in the UWB anchors 44 to detect contact and/or displacement of the UWB anchors 44. The UWB anchors 44 are utilized to generate the position data for tracking the portable devices within the interactive environment 14 (e.g., relative to the coordinate system), so displacement of the UWB anchors 44 may affect accuracy in tracking the portable devices, for example. Indeed, each of the UWB anchors 44 may include one or more respective sensors 154 for this purpose. The one or more respective sensors 154 may be utilized to detect the impact event and/or to provide information on displacement of the UWB anchors 44, as any displacement of the UWB anchors 44 may trigger an alert for maintenance, at least when the UWB anchors 44 are utilized to track the portable devices. Further, any displacement of the UWB anchors 44 may trigger removal of respective position data generated by the UWB anchors 44 (e.g., the impact detection system and/or the interactive system may not utilize the respective position data for tracking purposes until the UWB anchors 44 are inspected and/or repositioned). Indeed, in an embodiment, the impact detection system may track and respond to both impact events and displacement of the one or more components, as the impact events may occur independently of the displacement of the one or more components, for example.

It should be appreciated that any of the detection and tracking techniques may be applied to any type of the one or more components. For example, the position of the third portable device 16C may be tracked and compared to the location of the UWB anchors 44 according to the map to detect the impact event, in a similar manner as described herein to detect the impact event for the display 26. Further, respective UWB tags 24 and/or one or more respective sensors 154 may be incorporated into any type of the one or more components to monitor position and/or detect respective impact events, in a similar manner as described herein to detect the respective impact events for the physical interactive element 30 and the UWB anchors 44.

In an embodiment, the impact detection system may utilize only the UWB circuitry to determine the impact events. For example, the portable devices and the components may be devoid of IMUs and accelerometers, or at least such data is not utilized to detect impact events, position, and/or acceleration. In an embodiment, the impact detection system may utilize only the UWB circuitry to track the respective positions of the portable devices, (e.g., the portable devices are devoid of IMUs and accelerometers, or at least such data is not utilized to detect impact events, position, and/or acceleration), but may utilize IMUs or accelerometers included in at least some of the components to identify or confirm the impact events for such components.

In an embodiment, upon detection of the impact event, the impact detection system may perform a status check on the component that experienced the impact event. For example, with respect to the one of the UWB anchors 44, the impact detection system may send a request for data from the sensor 154 coupled to the one of the UWB anchors 44, send a request for data from the one of the UWB anchors 44, check respective position data provided by the one of the UWB anchors 44 against other position data provided by other UWB anchors, and so forth. In this way, the impact detection system may track and record information related to impact events, displacement, and/or operational status, which may be useful for maintenance purposes. The information may also be used to train machine learning models to improve predictions and outputs of the impact detection system.

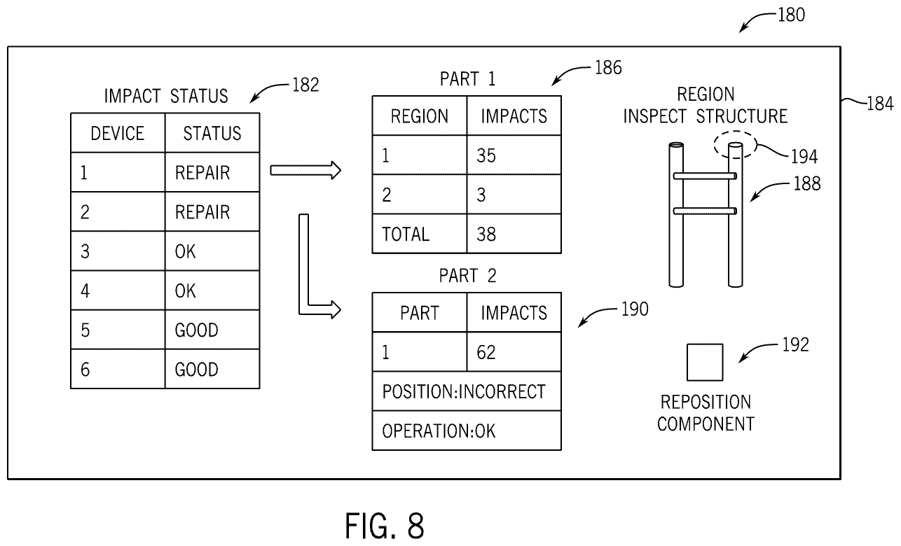

FIG. 8 is an example of a graphical user interface (GUI) 180 that presents a table 182 with respective impact statuses for multiple components, in accordance with present embodiments. For example, the multiple components may be any of the components shown or described with respect to FIG. 7. The GUI 180 may be presented on a display 184 (e.g., display screen), which may be part of or communicatively coupled to the control system 32 of FIG. 1. For example, the display 184 may be part of an operator work station, which may be located in a maintenance area associated with the interactive environment or in any other suitable area. Further, the display 184 may be part of a portable work station, such as a tablet computer that may be carried by an operator.

As shown, the GUI 180 may include the table 182, and the table 182 may include any of a variety of types of information. For example, the table 182 may include a respective identifier for each of the multiple components (e.g., part), as well as the respective statuses with respect to maintenance. The respective statuses may include text indicators such as “REPAIR,” “OK,” “GOOD,” and so forth. In some cases, the respective statuses may include numerical indicators, such as on a scale of one to ten, with one indicating a need for removal for maintenance and ten indicating no or few impact events. In some cases, the respective statuses may include numerical indicators, wherein the numerical indicators are a total tracked quantity of occurrences of impact events. For example, the table 182 may indicate the numerical indictor “38” instead of or in addition to the text indicator “REPAIR.” In any case, the table 182 may provide a summary of the respective statuses for the multiple components in a format that is easy to read and understand. In an embodiment, the table 182 may be color coded or provide other visual features to facilitate identification of the multiple components that should be obtained or pulled for maintenance operations. Further, entries in the table 182 may be sorted, filtered, or both based on the respective statuses and/or any other factors, such as component type. Indeed, the operator may provide inputs (e.g., the display 184 may be a touchscreen display) that enable the operator to sort, filter, or both, the entries in the table 182 according to preferences or to complete particular tasks.

In an embodiment, a respective impact profile 186 may be presented, such as upon selection of a respective component in the table 182. The respective impact profile 186 may include detailed information about the impact events for the respective component, such as a respective tracked quantity of occurrences of impact events for each of the different regions of the respective component. In an embodiment, additional visual indicators may be provided to facilitate understanding and/or maintenance by the operator, such as bold font and/or a text message to highlight that the respective total tracked quantity of occurrences of impact events for a particular region has exceeded a respective threshold. In an embodiment, a visual representation 188 of the respective component may be provided via the GUI 180, and the visual representation may include a marker 194 to surround or label the particular region and/or areas that should be inspected as part of the maintenance operations, which may facilitate inspection and repair by the operator.

In an embodiment, a respective impact profile 190 may be presented, such as upon selection of a respective component in the table 182. The respective impact profile 190 may include detailed information about the impact events for the respective component, such as a respective tracked quantity of occurrences of impact events for the respective component. In an embodiment, additional visual indicators may be provided to facilitate understanding and/or maintenance by the operator, such as text messages indicative of sensor data, position data, operational status, recommended actions, and so forth. In an embodiment, a visual representation 192 of the respective component may be provided via the GUI 180, which may facilitate inspection and repair by the operator. The respective impact profile 186 and the respective impact profile 190 may include different information, such as based on a type of the respective component, for example. In this way, the GUI 180 may provide component-specific information in an accessible format.

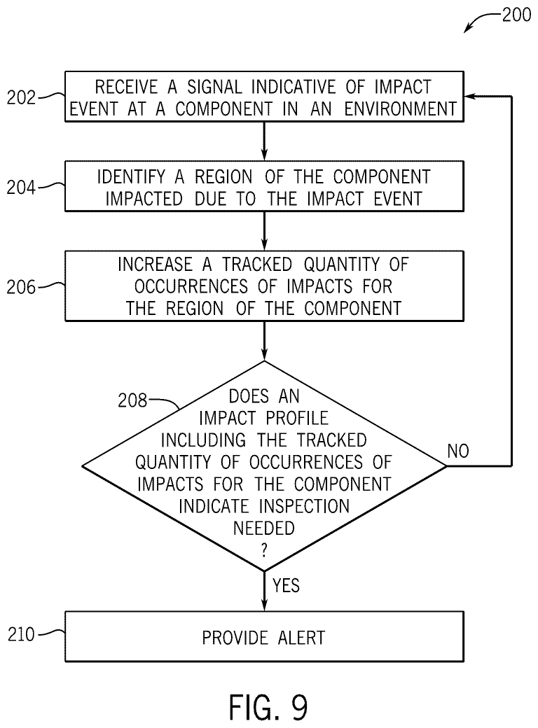

FIG. 9 is a flow diagram of a method 200 of operating an impact detection system, such as the impact detection system 10 of FIG. 1, to assess impact events for components in an interactive environment, in accordance with present embodiments. The method 200 includes various steps represented by blocks. It should be noted that at least some steps of the method 200 may be performed as an automated procedure by a processing system, such as the control system 32 of FIG. 1. Although the flow chart illustrates the steps in a certain sequence, it should be understood that the steps may be performed in any suitable order and certain steps may be carried out simultaneously, where appropriate. Additionally, steps may be added to or omitted from the method 200.

In block 202, the processing system may receive a signal indicative of an impact event for a component in an interactive environment. The signal may include or indicate positioning data obtained via UWB circuitry, such as UWB tags on a portable device and UWB readers in the interactive environment. In an embodiment, the processing system may access and reference a map of the interactive environment, wherein the map represents or indicates a location of the component within the interactive environment. For example, the map may represent or indicate the location of the component according to a coordinate system, such as a local coordinate system for the interactive environment. Thus, the processing system may compare a position of the portable device and based on the signal that includes or indicates the positioning data obtained via the UWB circuitry to the location of the component with respect to the coordinate system. If the position of the portable device overlaps with, intersects with, and/or corresponds to the location of the component within the interactive environment, then the processing system may identify contact between the portable device and the component within the interactive environment.

In block 204, the processing system may identify a region of the component impacted due to the impact event. For example, the processing system may process the positioning data obtained via the UWB circuitry to determine the position and an orientation of the portable device upon the contact between the portable device and the component within the interactive environment. Further, the processing system may determine the region of the portable device that contacted the component based on the position and the orientation of the portable device during the contact with the component.

As described herein, the processing system may also obtain other signals and/or data, such as acceleration data derived from the UWB circuitry or obtained from an IMU of the portable device, to identify occurrence of the impact event and/or to identify the region of the component that experiences contact during the impact event. For example, it should be appreciated that the acceleration data may indicate acceleration and/or change in acceleration for the portable device exceeds an acceleration threshold. This may trigger or cause the processing system to initiate block 202 to proceed with evaluation of the positioning data and the map, such as at limited times proximate to a time at which the acceleration for the portable device exceeds the acceleration threshold or otherwise indicates impact (e.g., acceleration constant due to gravity or high (e.g., high in magnitude) due to handling by the guest, and then reaches zero; corresponds to acceleration signature associated with or indicative of impact). In an embodiment, the processing system may carry out more complex evaluation of the acceleration data, such as via machine learning algorithms to determine that the acceleration (e.g., acceleration signature or pattern) likely corresponds to impact with a surface, which may be part of the component. Then, this may trigger or cause the processing system to initiate block 202 to proceed with evaluation of the positioning data and the map, such as at limited times proximate to a time at which the acceleration for the portable device indicates impact. Further, the processing system may consider the position and the orientation at the time at which the acceleration indicates impact to determine the region of the component impacted due to the impact event, as set forth in block 204.

Additionally or alternatively, the processing system may also obtain other signals and/or data, such as position data based on UWB tags in the component, acceleration data derived from the UWB tags in the component or obtained from one or more sensors coupled to the component, and/or other sensor data obtained via one or more sensors coupled to or associated with the component to identify occurrence of the impact event and/or to identify the region of the component that experiences contact during the impact event. For example, it should be appreciated that the sensor data may indicate movement (e.g., unexpected movement) of the component. This may trigger or cause the processing system to initiate block 202 to proceed with evaluation of the positioning data and the map, such as at limited times proximate to a time at which the acceleration for the portable device exceeds the acceleration threshold or otherwise indicates impact (e.g., acceleration constant due to gravity or high (e.g., high in magnitude) due to handling by the guest, and then reaches zero; corresponds to acceleration signature associated with or indicative of impact). In an embodiment, the processing system may carry out more complex evaluation, such as if the sensor data indicates the impact event and the position data indicates the impact event was not caused by contact with any portable device. For example, this may trigger or cause the processing system to assess imaging data to identify a source or cause of the impact event.

In block 206, the processing system may increase a respective tracked quantity of occurrences of impact events for the region of the component. For example, the respective tracked quantity of occurrences of impact events for the region of the component may increase by one. Further, a total tracked quantity of occurrences of impact events for the component may also increase by one. In certain cases, the processing system may increase the respective tracked quantity of occurrences of impact events for the component based on matching the respective position of the portable device to the respective location of the component in block 202, even if there is no additional sensor data to corroborate or verify the impact event and/or even if any additional sensor data does not corroborate or verify the impact event. In certain cases, the processing system may increase the respective tracked quantity of occurrences of impact events for the component based on the sensor data that indicates the impact event, even if the impact event was not caused by contact with any portable device.

In block 208, the processing system may determine whether an impact profile including the respective tracked quantity of occurrences of impact events for the region of the component indicates an inspection is needed. This may include comparing the respective tracked quantity of occurrences of impact events for the region of the component to a respective threshold for the region of the component. If the impact profile does not indicate inspection is needed, such as because the respective tracked quantity of occurrences of impact events for the region of the component does not exceed the respective threshold for the region of the component, the method 200 may return to block 202 to continue monitoring for additional impact events. However, if the impact profile indicates inspection is needed, such as because the respective tracked quantity of occurrences of impact events for the region of the component exceeds the respective threshold for the region of the portable device, the method 200 may continue to block 210.

In block 210, the processing system may generate or provide an alert. The alert may indicate that maintenance operations should be carried out for the component, such as inspection, repair, and so forth for the component. The alert may include an audible alert, a visual alert, or both. The alert may be provided via the component, via respective components off-board or separate from the component, or both. For example, the alert may include an audible alarm provided via a speaker of an operator work station and/or a visual alert provided via a display of the operator work station. In an embodiment, the alert may not be provided via the component while the component is in use by a guest in the interactive environment, so as not to detract from an interactive experience. Although, it should be appreciated that the alert may be provided via the component and/or via other systems at any time after the processing system determines that the alert should be provided and/or that maintenance operations should be carried out for the component based on the impact event(s).

As described herein, the processing system may determine that the alert should be provided based on other factors, such as certain high force impact events (e.g., high in magnitude), various combinations of impact events at different regions that are predicted or are likely to damage the component, and/or results of status check operations, for example. Thus, it should be appreciated that the block 208 may include another assessment or decision, such as an assessment of a respective impact profile for the component. The respective impact profile for the component may include respective impact events for the different regions of the component, the total tracked quantity of occurrences of impact events for the component, and so forth. In some cases, the respective impact profile for the component may include additional information, such as acceleration over time, position over time, orientation over time, and so forth for some time period before and/or after each impact event. Further, the additional information may include impact force and/or velocity at a time of impact for each impact event. In some cases, the respective impact profile for the component may also indicate or account for features of the portable device or other object that strikes the component (e.g., a material, a hardness, or other physical characteristics of the object), such as by counting respective events per type of device, applying weighting factors based on the features of the device (e.g., via counting, such as one impact event from a sharp object counts as two impact events, and one impact event from a jacket as one impact event; via inputs to machine learning algorithms), and so forth.

The processing system may be configured to evaluate various combinations of information to determine that the alert should be provided and/or that the maintenance operations should be carried out for the component based on the impact event(s). For example, the processing system may implement machine learning techniques with machine learning algorithms trained with training data to assess the various combinations of information to determine that the maintenance operations should be carried out for the component based on the impact event(s), to set the respective thresholds, and so forth. It should be appreciated that the method 200 may be carried out for multiple components simultaneously and over time, such that the processing system effectively and efficiently monitors respective health and maintenance statuses for the multiple components. Further, the method 200 may be carried out for multiple components in real time (e.g., substantially real time), including while the multiple components are carried by guests through the interactive environment.

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that features shown in FIGS. 1-9 and described with reference to FIGS. 1-9 may be combined in any suitable manner. Further, as described herein, UWB circuitry may be utilized to determine position, orientation, acceleration, and/or velocity. Thus, it should be appreciated that UWB circuitry may be used instead of IMUs in any examples that refer to use of IMUs to determine position, orientation, acceleration, and/or velocity. Further, aspects of examples with a particular component (e.g., display) may be applied to techniques to assess impact events for any other component (e.g., rail, gate, ride vehicle). Further, the systems and methods described herein may be applied to detect collisions (e.g., detect and count impact events) of two or more of the portable devices with one another and/or collisions (e.g., detect and count impact events) of the portable device with guests, other items carried by the guests (e.g., backpacks, purses, toys, and/or mobile phones carried by the guests), and so forth.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform) ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An impact detection system, comprising:
processing circuitry comprising one or more processors; and
memory storing instructions, that when executed by the processing circuitry, cause the processing circuitry to:
process positioning data to determine a position of a portable device within an interactive environment;
compare the position of the portable device to a location of a component within the interactive environment;
identify an occurrence of an impact event based on the position of the portable device and the location of the component; and
update an impact profile for the component based on the occurrence of the impact event.

2. The impact detection system of claim 1, wherein the instructions, when executed by the processing circuitry, cause the processing circuitry to:
process the positioning data to determine an orientation of the portable device within the interactive environment;
determine a region of the component that contacts the portable device based on the position and the orientation of the portable device within the interactive environment during the occurrence of the impact event; and
update the impact profile for the component to record the region of the component that contacts the portable device.

3. The impact detection system of claim 1, wherein the instructions, when executed by the processing circuitry, cause the processing circuitry to update the impact profile for the component by adding the impact event to a tracked quantity of occurrences of impact events associated with the component.

4. The impact detection system of claim 3, wherein the instructions, when executed by the processing circuitry, cause the processing circuitry to:
compare the number of impact events associated with the component to a threshold for the component; and
provide an alert in response to the number of impact events associated with the component meeting or exceeding a threshold for the component.

5. The impact detection system of claim 4, wherein the instructions, when executed by the processing circuitry, cause the processing circuitry to instruct the component to provide the alert as an audible alarm, a visual alarm, or both.

6. The impact detection system of claim 3, wherein the instructions, when executed by the processing circuitry, cause the processing circuitry to:
input the number of impact events associated with the component into a machine learning algorithm to determine whether maintenance should be performed for the component; and
provide an alert in response to determining that the maintenance should be performed for the component.

7. The impact detection system of claim 1, wherein the instructions, when executed by the processing circuitry, cause the processing circuitry to:
process sensor data to identify a possible impact event at the component; and
in response to identifying the possible impact event at the component:
process the positioning data to determine the position of the portable device within the interactive environment;
compare the position of the portable device to the location of the component within the interactive environment;
identify the occurrence of the impact event based on the position of the portable device and the location of the component; and
update the impact profile for the component based on the occurrence of the impact event.

8. The impact detection system of claim 7, wherein the sensor data comprises motion data indicative of unexpected motion of the component.

9. The impact detection system of claim 1, wherein the component comprises a display, a speaker, a light source, a camera, a ride vehicle, a physical interactive element, or any combination thereof.

10. The impact detection system of claim 1, wherein the component comprises an ultra-wideband anchor.

11. The impact detection system of claim 1, wherein the portable device is configured to facilitate interactions with interactive elements in the interactive environment, and the portable device comprises a handheld targeting device, a wand, a toy, a figurine, an article of clothing, a wearable accessory, augmented reality (AR) glasses, virtual reality (VR) glasses, or any combination thereof.

12. The impact detection system of claim 1, wherein the positioning data comprises a signal generated by ultra-wideband (UWB) circuitry.

13. The impact detection system of claim 12, comprising UWB readers in the interactive environment that are configured to read UWB tags in the portable device to generate the positioning data.

14. An interactive system, comprising:
a component positioned in an interactive environment, wherein the component comprises an array of ultra-wideband (UWB) tags, one or more sensors, or both;
a control system comprising one or more processors; and
memory storing instructions, that when executed by the control system, cause the control system to:
process data to determine occurrence of an impact event at the component, wherein the data is generated by UWB anchors based on communication with the array of UWB tags, by the one or more sensors, or both;
update an impact profile for the component based on the occurrence of the impact event; and
assess the updated impact profile for the component to identify maintenance operations due for the component.

15. The interactive system of claim 14, wherein the instructions, when executed by the control system, cause the control system to:
process positioning data to determine a position of a portable device in the interactive environment; and
determine the impact event occurred via contact between the component and the portable device based on the position of the portable device relative to a location of the component in the interactive environment during the occurrence of the impact event.

16. The interactive system of claim 15, wherein the component comprises the UWB tags, and wherein the instructions, when executed by the control system, cause the control system to:
determine the location of the component in the interactive environment based on the data, wherein the data is generated by UWB anchors based on communication with the array of UWB tags.

17. The interactive system of claim 15, wherein the instructions, when executed by the control system, cause the control system to:
access a map of the interactive environment to determine the location of the component in the interactive environment.

18. The interactive system of claim 14, wherein the component comprises a display, a speaker, a light source, a camera, a ride vehicle, a physical interactive element, an ultra-wideband anchor, or any combination thereof.

19. A method of operating an impact detection system, the method comprising:
processing positioning data generated by ultra-wideband circuitry to identify an occurrence of an impact event for a component;
updating an impact profile for the component based on the occurrence of the impact event; and
assessing the updated impact profile for the component to identify maintenance operations due for the component.

20. The method of claim 19, comprising:
processing the positioning data generated by the ultra-wideband circuitry to determine an unexpected movement of the component, a respective position of a portable device, or any combination thereof to identify the occurrence of the impact event for the component.
